(19) United States
(12) Patent Application Publication
(10) Pub. No.: US 2026/0017760 A1
(43) Pub. Date: Jan. 15, 2026

(54) Atmospheric correction

(71) Applicant: Commonwealth Scientific and Industrial Research Organisation, Acton ACT (AU)

(72) Inventors: Ali Cheraghian, Acton ACT (AU); Miaohua Zhang, Acton ACT (AU); Yi Qin, Acton ACT (AU); David Benn, Acton ACT (AU); Nariman Habili, Acton ACT (AU)

(21) Appl. No.: 19/266,579

(22) Filed: Jul. 11, 2025

(30) Foreign Application Priority Data
Jul. 12, 2024 (AU) 2024902159

(51) Int. Cl. G06T 5/60; G06T 5/80

(52) U.S. Cl. CPC G06T 5/60; G06T 5/80; G06T 2207/10036; G06T 2207/20081; G06T 2207/20084; G06T 2207/30181

(57) ABSTRACT

This disclosure relates to machine learning models for performing atmospheric correction on an input image. To train a machine learning model to perform atmospheric correction on an input image comprising atmospheric distortion, a processor applies a first trained machine learning model to a training image to determine a first output image, the first trained machine learning model being configured to perform atmospheric correction on an input image comprising atmospheric distortion. The processor applies a second machine learning model to the training image to determine a second output image, wherein the second machine learning model has a smaller model architecture than the first trained machine learning model. The processor trains the second machine learning model by minimising a loss based on the first output image and the second output image to determine a second trained machine learning model.

### CROSS-REFERENCE TO RELATED APPLICATIONS

The present application claims priority from Australian Provisional Patent Application No 2024902159 filed on 12 Jul. 2024, the contents of which is incorporated herein by reference in its entirety.

### TECHNICAL FIELD

This disclosure relates to machine learning models for performing atmospheric correction on an input image.

### BACKGROUND

Imagery of the Earth's surface can be captured by systems, such as a satellite, high altitude balloon, aircraft or drone, which is deployed in, near or above the Earth's atmosphere. However, the Earth's atmosphere introduces distortion to the radiometric values recorded by remote sensing sensors, such as image sensors of the previously mentioned systems, primarily due to interactions with aerosols, gases, and water vapor. As such, images of the Earth captured from the atmospheric often contain distortion or noise, which results in a distorted view of the Earth. Image processing techniques may be used to reduce the distortion in these images, which is referred to as atmospheric correction.

Atmospheric correction is useful in remote sensing to ensure the accuracy and reliability of acquired imagery. This correction is particularly important in applications such as land cover classification, environmental monitoring, and change detection, where precise and consistent radiometric information is required for accurate interpretation and decision-making. Some atmospheric correction methods utilise machine learning and collectively aim to mitigate the impact of atmospheric constituents, allowing for the extraction of intrinsic surface properties and enhancing the quality and interpretability of remote sensing data.

However, machine learning methods in atmospheric correction are computationally intensive and require significant optimisation effort for use in an onboard processing context. In particular, it is difficult to onboard a machine learning model to a satellite with a resource-constraint processor as atmospheric correction involving machine learning is computationally intense.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Disclosed herein are methods and systems for performing atmospheric correction on an input image. In particular, the disclosed methods and systems relate to training and application of machine learning models, such that the computational intensity of training and inference of such machine learning models is reduced. As such, the resulting machine learning models are advantageous for onboarding in different systems with minimal computational power.

According to the present disclosure, there is provided a method for training a machine learning model to perform atmospheric correction on an input image comprising atmospheric distortion, the method comprising:
applying a first trained machine learning model to a training image to determine a first output image, the first trained machine learning model being configured to perform atmospheric correction on an input image comprising atmospheric distortion;
applying a second machine learning model to the training image to determine a second output image, wherein the second machine learning model has a smaller model architecture than the first trained machine learning model; and
training the second machine learning model by minimising a loss based on the first output image and the second output image to determine a second trained machine learning model.

It is an advantage to train the second machine learning model by minimising the loss based on the first output image and the second output image as the knowledge of the first trained machine learning model can be transferred to the second machine learning model. This means that the second machine learning model can be trained without a large model architecture and with minimal training time, while achieving a similar performance to the first trained machine learning model during inference.

In some embodiments, the first trained machine learning model is trained at least partially on a synthetic dataset comprising synthetic images, wherein the synthetic dataset comprises the training image.

In some embodiments, the synthetic dataset is generated at least partially from top of atmosphere (TOA) images by applying a correction to the TOA images to reduce the atmospheric distortion.

In some embodiments, the synthetic dataset is generated at least partially from surface reflectance images by simulating one or more atmospheric conditions in the surface reflectance images.

In some embodiments, applying the correction and simulating the one or more atmospheric conditions is based on a physical reflectance model, the physical reflectance model being indicative of a relationship between TOA reflectance and surface reflectance.

In some embodiments, the surface reflectance images are generated from the TOA images using the physical reflectance model.

In some embodiments, the physical reflectance model is configured using one or more atmospheric parameters, the one or more atmospheric parameters being one or more of:
aerosol type;
optical depth;
water vapor;
surface elevation;
view zenith;
azimuth angle; and
solar zenith angle.

In some embodiments, the method further comprises determining a compressed machine learning model by applying a quantisation algorithm or layer fusion algorithm to the second trained machine learning model, the compressed machine learning model having a smaller model architecture than the second trained machine learning model.

In some embodiments, the first trained machine learning model and the second machine learning model are a neural network comprising one or more convolutional blocks, each of the one or more convolutional blocks comprising one or more convolutional layers.

In some embodiments, each of the one or more convolutional layers comprise a number of convolutional kernels, wherein the convolutional kernels of the first trained machine learning model are three-dimensional, and the convolutional kernels of the second machine learning model are two-dimensional.

In some embodiments, a number of the convolutional blocks of the second machine learning model is less than a number of convolutional blocks of the first trained machine learning model.

In some embodiments, the second machine learning model comprises two convolutional blocks and each of the two convolutional blocks comprises one convolutional layer.

In some embodiments, the first trained machine learning model and the second machine learning model are based on a UNet architecture.

In some embodiments, the images are hyperspectral images.

According to the present disclosure, there is provided a method for training a machine learning model to perform atmospheric correction on an input image comprising atmospheric distortion, the method comprising:
partially training the machine learning model using a synthetic dataset comprising synthetic images, the synthetic dataset being generated from surface reflectance images by simulating one or more atmospheric conditions in the surface reflectance images;
determining one or more frozen layers of the partially trained machine learning model, the one or more frozen layers corresponding to layers with fixed weights in subsequent training; and
training the partially trained machine learning model based on the one or more frozen layers using the surface reflectance images to finely tune the partially trained machine learning model and thereby, determine a trained machine learning model.

According to the present disclosure, there is provided a method for atmospheric correction of an image comprising atmospheric distortion, the method comprising:
receiving the image;
applying a trained machine learning model to the image, the trained machine learning model being trained using any one of the previously mentioned methods; and
determining a corrected image based on an output of the trained machine learning model.

According to the present disclosure, there is provided software that, when executed by a computer, causes the computer to perform the any one of the previously mentioned methods.

According to the present disclosure, there is provided a system for training a machine learning model to perform atmospheric correction on an input image comprises atmospheric distortion, the system comprising a processor configured to perform the method of any one of the previously mentioned methods for training a machine learning model.

According to the present disclosure, there is provided a system for atmospheric correction of an image comprising atmospheric distortion, the system comprising a processor configured to perform the previously mentioned method for atmospheric correction of an image.

In some embodiments, the system is one of:
an atmospheric satellite;
a high-altitude balloon;
an aircraft; and
a drone.

Optional features provided in relation to the first method, equally apply as optional features to the second and third methods, as well as the software and the systems.

### BRIEF DESCRIPTION OF DRAWINGS

An example will be described with reference to the following drawings:

FIG. 1 illustrates an example system for atmospheric correction.

FIG. 2 illustrates a method for training a machine learning model to perform atmospheric correction using knowledge distillation.

FIG. 3 illustrates a method for training a machine learning model to perform atmospheric correction using layer freezing.

FIG. 4 illustrates a data structure for a hyperspectral image.

FIG. 5 illustrates a 3D convolution applied to the data structure from FIG. 4.

FIG. 6 illustrates a method for atmospheric correction of an image.

FIG. 7 illustrates the atmospheric correction workflow used to obtain the experimental results described herein.

FIG. 8 shows a flow chart for the generation of simulated Hyperion imagery for the experiments described herein.

FIG. 9 shows the spatial distribution of the Hyperion images used to provide input surface reflectance to the simulation of TOA reflectance, showing wide spatial coverage.

FIG. 10a show an example TOA reflectance image used to generate a surface reflectance satellite image.

FIG. 10b shows the resulting surface reflectance image after the first order correction of the TOA reflectance image of FIG. 10a.

FIG. 11a show a further example TOA reflectance image used to generate a surface reflectance satellite image.

FIG. 11b shows the resulting surface reflectance image after the first order correction of the TOA reflectance image of FIG. 11a.

FIG. 12a shows an example simulated TOA reflectance image.

FIG. 12b shows the input surface reflectance image used to generate the example simulated TOA reflectance image of FIG. 12a.

FIG. 13 shows the training convergence curves from different atmospheric correction methods.

FIG. 14a shows an example of a visualization of TOA reflectance for land and water surfaces.

FIG. 14b shows an example of a visualization of surface reflectance for land and water surfaces.

FIG. 14c shows an example of a visualization of inferred surface reflectance for land and water surfaces.

FIG. 15a shows a further example of a visualization of TOA reflectance for land and water surfaces.

FIG. 15b shows a further example of a visualization of surface reflectance for land and water surfaces.

FIG. 15c shows a further example of a visualization of inferred surface reflectance for land and water surfaces.

FIG. 16a shows the TOA reflectance, inferred surface reflectance and the surface reflectance (from the physics-based model) as spectral plots for a pixel for the images in FIGS. 14a-c.

FIG. 16b shows the TOA reflectance, inferred surface reflectance and the surface reflectance (from the physics-based model) for a pixel for the images in FIGS. 15a-c.

### DESCRIPTION OF EMBODIMENTS

This disclosure provides a computationally efficient machine learning (as referred to as artificial intelligence (AI)) based atmospheric correction method suitable for onboard processing, such as on a satellite or other resource-constrained systems. A lightweight machine learning model is developed, and knowledge distillation (or the student-teacher framework) is used to train the lightweight machine learning model. More specifically, a larger (teacher) machine learning model is trained to perform atmospheric correction on captured images, then the knowledge of the larger model is transferred to the smaller (student) model. As the lightweight machine learning model has a smaller model architecture than the larger model, this significantly improves computational efficiency and reduces model size while maintaining effectiveness.

The term “lightweight” refers to the compactness in terms of memory and computational demands. In other words, the model architecture of a lightweight machine learning model is smaller than a standard machine learning model architecture. For example, lightweight machine learning models may only have one to a few layers, as compared to standard machine learning models, which may comprise many more layers (ten layers or more, in some cases). Further, standard machine learning models may have millions of parameters (i.e., the learnable weights), whereas lightweight machine learning models may only have a few thousand parameters.

The lightweight machine learning model may also undergo further reduction in model size, through quantisation, for example, to enable deployment on resource-constraint systems, such as the Raspberry Pi 4 (RPi4) platform, offering an efficient solution for fast onboard processing in resource-constrained space-borne systems (such as atmospheric satellites). RPi4 is recognized for its computational efficiency and compact form factor and aligns with the computational constraints of spaceborne platforms, offering a practical solution for autonomous, onboard processing. However, the lightweight model described herein may also be implemented using other resource-constrained computer hardware and is not limited to implementation using a Raspberry Pi.

In this disclosure, a synthetic dataset is also proposed for overcoming the scarcity and variability of real-world training data. By creating controlled, diverse, and representative datasets, the adaptability of machine learning models described herein are enhanced to a wide array of atmospheric conditions. Further, many training images may be generated in the synthetic dataset, enabling an ample amount of training data. In the experiments described herein, the disclosed synthetic dataset was derived from Hyperion imagery covering the Australian landmass and corrected using a first order physics-based atmospheric correction method. However, other atmospheric correction methods and other real-world image databases can also be used to create the synthetic dataset. In essence, the synthetic data described herein enables the disclosed machine learning model to effectively learn and generalize, ensuring robust performance.

### System

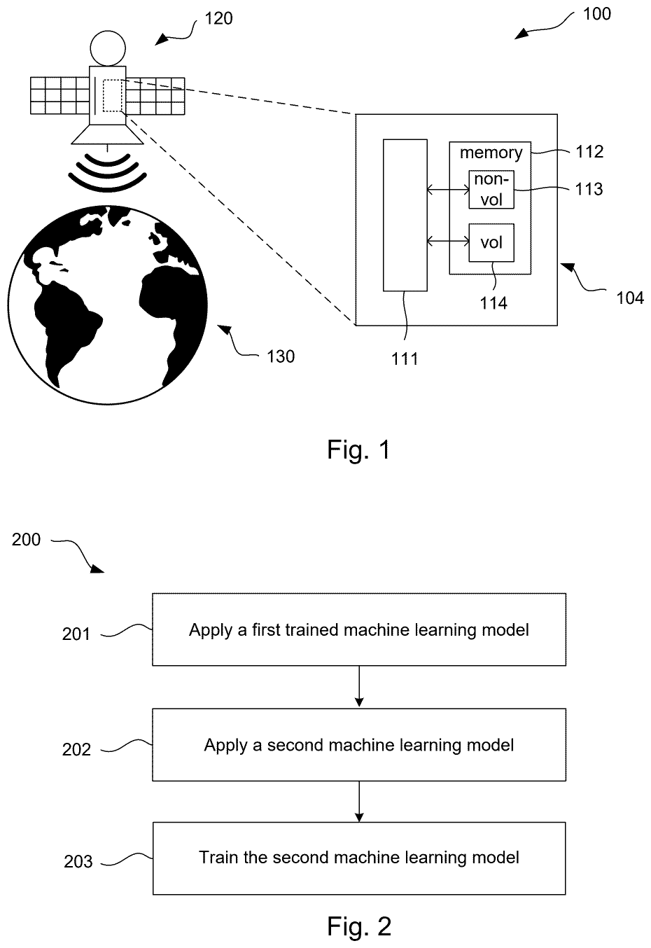

FIG. 1 illustrates an example system 100 for atmospheric correction. FIG. 1 is one example of a configuration of system 100. However, system 100 is not strictly limited to this configuration and this may be one possible embodiment of system 100. It is noted that system 100 of FIG. 1 is only meant to illustrate an example and a preferred system which is capable of performing the disclosed methods.

System 100 comprises device 110, which may be smartphone, computer, tablet, a server device, or any other similar device. Device 110 may also be a field-programmable gate array (FPGA), an application specific integrated circuits (ASIC), or one or more single board computers, such as a Raspberry Pi or an Arduino. Device 110 comprises processor 111, which may be configured to perform the methods described in this disclosure. Device 110 comprises memory 112, which comprises non-volatile memory 113 and/or volatile memory 113. Processor 111 may communicate with memory 112 by communicating with non-volatile memory 113 and/or volatile memory 114. Non-volatile memory 113 is a non-transitory computer readable medium and may be an optical disk drive, hard disk drive, solid-state drive, flash memory, storage server, cloud storage or another equivalent type of memory. Volatile memory 114 may be cache, RAM, or another equivalent type of memory.

Device 110 may be part of system 120, which is an airborne or space-borne system. While system 120 is depicted as a satellite (e.g., an atmospheric satellite) in FIG. 1, it is noted that system 120 may be any other types of airborne or space-borne systems, such as, but not limited to, a high-altitude balloon, aircraft (including Airborne early warning and control Systems (AWACS)) or a drone. System 120 may be configured to capture images of the Earth's 130 surface. For example, system 120 may comprise an image sensor, which may capture an image of the Earth's 130 surface and communicate the image to processor 111. The images may be satellite images, for example. In other examples, device 110 may be in communication with system 120. For example, system 120 may be in the Earth's 130 atmosphere, while device 110 is on the Earth's 130 surface.

Memory 112 may store data to be retrieved for later use. For example, memory 112 may store images which includes training images (e.g., images from a synthetic dataset), and corrected images. Memory 112 may also store atmospheric parameters used to configure a physics-based model for creating the synthetic dataset. In essence, memory 112 may store any data used by processor 111 when performing the methods described herein. The data thereof may be stored in memory 112 in the form of a JSON format file, XML format file or another equivalent data format file. The images may be stored in memory 112 in a Joint Photographic Experts Group (JPEG) format, RAW data format, or another equivalent data format. It is noted that the reference to “image” in this disclosure refers to “image data”, which may be two-dimensional image data, three-dimensional image data or multi-dimensional image data (in the case of multi-spectral or hyperspectral images). In some examples, the images may be hyperspectral images and hence, may be stored on memory 112 in band sequential (BSQ), band-interleaved-by-pixel (BIP), or band-interleaved-by-line (BIL) encoding formats, or another equivalent format.

The methods described herein comprise applying one or more trained machine learning models. These machine learning models may be stored on memory 112 by storing the weights that form the respective models, for example. Memory 112 may also store any output values calculated by processor 111 applying the one or more machine learning models, or any other variable or data necessary to perform such methods described herein.

Software, that is, an executable program stored on non-volatile memory 113 causes processor 111 to perform methods for training a machine learning model or performing atmospheric correction. While the singular of “processor” is used herein, it is meant to also encompass multiple processors that are individually or together configured (e.g., programmed) to perform the methods disclosed herein. As such, processor 111 may refer to multiple central processing units (CPUs) and/or graphical processing units (GPUs) that are configured to collectively perform the methods disclosed herein.

Once executed, the software may cause processor 111 to apply a first trained machine learning model to a training image, apply a second machine learning model to the training image, and train the second machine learning model. Similarly, once executed, the software may cause processor 111 to partially train a machine learning model, determine one or more frozen layers, and train the partially trained machine learning model based on the one or more frozen layers. Further, once executed, the software may cause processor 111 to receive an image, apply a trained machine learning model to the image, and determine a corrected image.

Software may provide a user interface (such as a graphical user interface) presented to the user on device 110. The user interface may be configured to accept input (via buttons or text fields etc) from the user, via a touch screen or a device attached to device 110 such as a keyboard or computer mouse. These devices may also include a touchpad, an externally connected touchscreen, a joystick, a button, and a dial. In an example, the user interface may display multiple images and a user may choose one of the multiple images by interacting with the user interface. The user interaction may then cause processor 111 to perform a method of atmospheric correction on the chosen image.

### Methods for Training

### Training by Knowledge Distillation

FIG. 2 illustrates method 200 for training a machine learning model to perform atmospheric correction on an input image comprising atmospheric distortion. FIG. 2 is to be understood as a blueprint for a software program and may be implemented step-by-step, such that each step in FIG. 2 is represented by a function in a programming language, such as, but not limited to, Python, C++, or Java. The resulting source code is then compiled and stored as computer-executable instructions on non-volatile memory 113, which causes processor 111 (or multiple processors or a distributed computing architecture) to perform method 200. The input image may be a satellite image, for example.

Atmospheric distortion comprises noise in the images caused by natural atmospheric processes of the atmosphere itself. More specifically, atmospheric distortion corresponds to distortion that are present in captured images, which are due to interactions of captured light with aerosols, gases, and water vapor in the atmosphere. Atmospheric distortion may be cloud interference, for example.

Processor 111 applies 201 a first trained machine learning model to a training image to determine a first output image. The first trained machine learning model is configured to perform atmospheric correction on an input image comprising atmospheric distortion. The training image may be a captured image, such as an image captured using a hyperspectral image senor, for example. The first output image may be a corrected image or indicative of a corrected image. The training image and the first output image may be satellite images, for example.

Processor 111 then applies 202 a second machine learning model to the training image to determine a second output image. The second machine learning model has a smaller model architecture than the first trained machine learning model. As such, the second machine learning model may be referred to as a “lightweight” model. In some examples, the first and second machine learning model may be of a similar model architecture, such as a ResNet, UNet or EfficientNet. In other examples, the first and second machine learning model may be different model architectures. Similar to the first output image, the second output satellite may be a corrected image or indicative of a corrected image. The second output input may be a satellite image.

Finally, processor 111 trains 203 the second machine learning model by minimising a loss based on the first output image and the second output image. As such, the second machine learning model may be trained based on an output of the first trained machine learning model. In other words, the second machine learning model may be adapted to produce a similar output to the first trained machine learning model. This process may be referred to as knowledge distillation or student-teacher training, where the first trained machine learning model represents the teacher that bestows knowledge to the second machine learning model representing the student.

The loss may be based on a difference between the first output image and the second output image. For example, the loss may be based on a sum of the difference between each corresponding pixel value between the first and second output image. Processor 111 may calculate the loss by applying an algorithm or mathematical equation to the first and second output image. For example, the loss may be based on a mean square error between the first and second output image. The loss may be based on other error formulations.

In some examples, processor 111 trains 203 the second machine learning model by minimising a loss based on the first output image, the second output image and a ground truth of the training image to determine a second trained machine learning model. The ground truth of the training image may be a corrected image. The ground truth of the training image may be the desired output of the second machine learning model. In some examples, the ground truth of the training image is determined by applying an atmospheric correction algorithm to the training image. However, in other examples, the atmospheric correction algorithm may simply be the first machine learning model and hence, the ground truth may be the same as the first output image. Therefore, processor 111 trains 203 the second machine learning model by minimising a loss based on the first output image and the second output image, rather than using a separate ground truth.

### Training by Freezing Layers

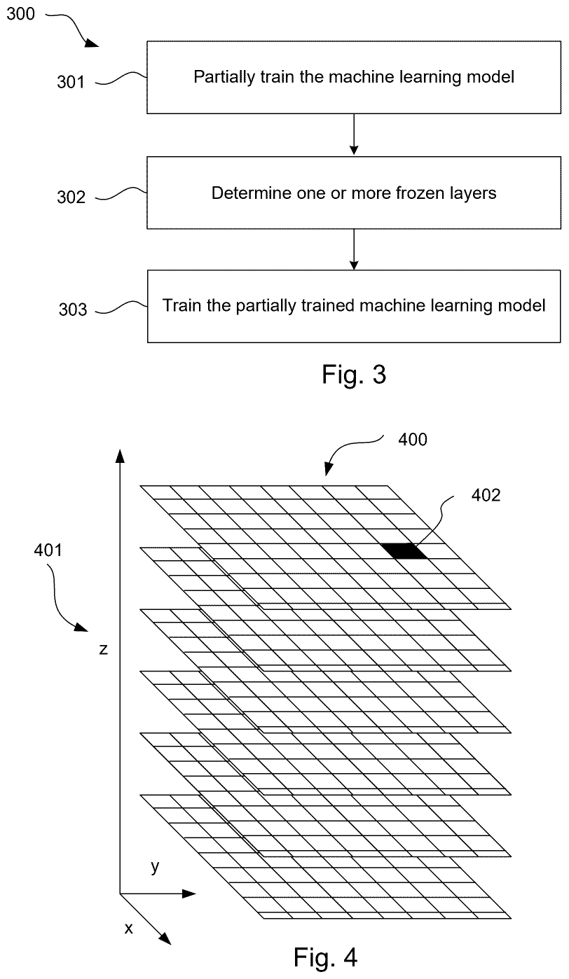

FIG. 3 illustrates method 300 for training a machine learning model to perform atmospheric correction on an input image comprising atmospheric distortion. Similar to FIG. 2, FIG. 3 is to be understood as a blueprint for a software program.

Processor 111 partially trains 301 the machine learning model using a synthetic dataset comprising synthetic images. The synthetic dataset is generated from surface reflectance images by simulating one or more atmospheric conditions in the surface reflectance images. Other embodiments of the synthetic dataset are discussed later in this disclosure. The machine learning model of method 300 may be the same or similar to the second machine learning model of method 200 (i.e., the machine learning model of method 300 may be a “lightweight” model).

Partially training the machine learning model may refer to training the machine learning model using a subset of the synthetic dataset. In some examples, partially training the machine learning model may refer to training the machine learning model below the desired accuracy. For example, the partially trained machine learning model may only partially correct the input image, such that there is still significant atmospheric distortion in the image. In other examples, partially training the machine learning model simply indicates that the machine learning model undergoes further training. In other words, partial training may be part of the overall training process.

Processor 111 determines 302 one or more frozen layers of the partially trained machine learning model. The one or more frozen layers corresponding to layers with fixed weights in subsequent training. More specifically, determining 302 one or more frozen layers comprises determining weights of the machine learning model that do not change in subsequent training of the machine learning model. In the case of the machine learning model being a neural network, a “layer” may be considered to be the corresponding neurons, which have weights on either side (if the layer is not the input or output layer). The weights of a frozen layer may be the weights between the previous layer and the frozen layer, the weights between the following layer and the frozen layer, or both.

In some embodiments, a user determines 302 the one or more frozen layers. In some examples, processor 111 determines 302 the one or more frozen layers randomly. In other examples, processor 111 determines 302 the one or more frozen layers based on predetermined conditions. Preferably, the machine learning model is a deep neural network (i.e., has one or more hidden layers) and the one or more frozen layers are determined from the one or more hidden layers.

Freezing one or more layers of the machine learning model may enable the machine learning model to be fine-tuned during training. In other words, determining 302 one or more frozen layers preserves the good knowledge of the machine learning model after partially training 301, while enabling fine-tuning of the machine learning model to achieve the desired accuracy of the machine learning model.

Finally, processor 111 trains 303 the partially trained machine learning model based on the one or more frozen layers using the surface reflectance images to finely tune the partially trained machine learning model and thereby, determine a trained machine learning model. More specifically, the weights of the one or more frozen layers do not change in this subsequent training using the surface reflectance images. In other words, the partially trained machine learning model is fine-tuned using the corrected images. This adapts the partially trained machine learning model to output images similar to the corrected images (i.e., the surface reflectance images). Partially training 301 the machine learning model and training 303 the partially trained machine learning model may be performed using similar machine learning techniques or different machine learning techniques.

It is noted that method 300 may be used in conjunction with method 200. More specifically, a machine learning model may be trained through the process of knowledge distillation described in method 200 while freezing one or more layers according to method 300.

### Machine Learning Models

The machine learning models described in this disclosure (including the first machine learning model and second machine learning model of method 200, and the machine learning model of method 300) are understood to be models, such as mathematical models, which receive input and generate an output based on the input. The machine learning models may be of an architecture, such as, but not limited to, a neural network, for example. In general, machine learning models are ‘trained’ to learn and recognise patterns in an input and provide an output that is a prediction based on the training it has undergone. Training involves updating weights or parameters of the machine learning model, which define the machine learning models, to minimise a loss value, thereby creating a trained machine learning model (in other words, a machine learning model trained to generate an output). This may involve a gradient descent and backpropagation method.

The machine learning models recited in this disclosure may be stored on memory 112 storing the weights that define the model. As such, each of the machine learning models may be referred to as a “memory model”, given that it is defined by parameters (i.e., the weights) which can be stored on computer memory. In some embodiments, the machine learning models may be programmed on an integrated circuit, such as a field-programmable gate array (FPGA) or an NVIDIA processing unit. In such an embodiment, the handling modules (or processor(s) that may perform the method or part thereof) may not retrieve the parameters from memory 112. Instead, an input may be communicated to the integrated circuit and the integrated circuit may apply the machine learning model to the input and generate an output, which is then communicated to the handling modules (or processor(s) that may perform the method or part thereof).

Integrated circuits, such as FPGAs, can be used where flexibility, speed, and parallel processing capabilities are desired. In such an embodiment, the integrated circuit may be part of device 110 of system 100 and may be considered as a “processor” or “processing unit”. Other implementations, such as application specific integrated circuits (ASIC) or neuromorphic architectures are equally useable.

Applying, executing, or evaluating the machine learning models may involve calling an API routine to send the input to a server and the server then performs the calculations according to the machine learning model and returns the results. In other examples, applying, executing, or evaluating may involve issuing a command to local hardware, such as a local chip, device, machine learning accelerator (e.g., a USB device design to efficiently perform machine learning tasks or NVIDIA's Deep Learning Accelerator (DLA)), etc., that has the machine learning model stored thereon and provides a command interface to interact with the model. It is also possible to have a local copy of the machine learning model available so that the calculations are performed by the main processor of the local machine. Other local, remote, or distributed implementations (such as cloud computing environments) are equally useable.

In some examples, the machine learning models described herein may be a neural network. In further examples, these machine learning models may be a neural network comprising one or more convolutional layers. As such, the machine learning models may perform the methods described herein by creating feature maps using convolutional filters. Such a machine learning model is known as a convolutional neural network (CNN). A CNN is ideal for applications involving images and the image as it accounts for the positioning and shape of objects captures in the image.

However, other types of machine learning models are equally applicable here, such as K nearest neighbour, decision tree, support vector machines, regression models and other artificial neural networks, such as long short-term memory (LSTM) networks or deep neural networks. The machine learning models described herein may also be a collective of different models. The machine learning models may also be based on a transformer models, which comprises encoder and/or decoder blocks and predictions by ‘tokenising’ the input (such as an image). As such, the machine learning models may also comprise self-attention. The machine learning models may output (and hence, the multiple machine learning outputs may be) a numerical value, a generated output (such as a generated image) or some other type of output (such as a word or sentence).

In some embodiments, the machine learning models are a multimodal machine learning model, in which multiple inputs of different modalities (e.g., text, image data and audio data) are used to provide one or more generated outputs. An example of a multimodal machine learning model is an object detection model, which detects the location of a specific object (specified by input text, for example) in an image. This example model may generate output text that describes the location of the specified object in the image. Although the multimodal machine learning model can be evaluated on multiple input of different modalities, the multimodal machine learning model can also be evaluated on a single input and still generate an output based on the single input.

In some embodiments of method 200,300, the method further comprises determining a compressed machine learning model. For example, with reference to method 200, the compressed machine learning model has a smaller model architecture than the second trained machine learning model. With reference to method 300, the compressed machine learning model has a smaller model architecture than the trained machine learning model. The compressed machine learning model may also be considered as a trained machine learning model.

Processor 111 may determine the compressed machine learning model by applying an algorithm, mathematical equation of a further machine learning model to the second trained machine learning model. For example, processor 111 may determine the compressed machine learning model by applying a quantisation algorithm or layer fusion algorithm to the second trained machine learning model. Other machine learning model compression algorithms and techniques are equally applicable here. In other examples, processor 111 may determine the compressed machine learning model by applying a combination of a quantisation algorithm, layer fusion algorithm or other model compression algorithms.

Quantisation in machine learning is the process of approximating a neural network that uses floating-point numbers by a machine learning model of low bit width numbers. This dramatically reduces both the memory requirement and computational cost of using the machine learning model. Layer fusion is a model compression technique that fuses weights between layers. Some layer fusion algorithms discover which weights to combine and then fuses weights of similar fully connected, convolutional and attention layers. Layer fusion can significantly reduce the number of layers of the original network with little additional computation overhead, while maintaining competitive performance

### Convolutional Neural Networks

As previously discussed, the machine learning models recited in this disclosure may be a convolutional neural network (CNN). More specifically, the first trained machine learning model and the second machine learning model of method 200 may be a neural network comprising one or more convolutional blocks, each of the one or more convolutional blocks comprising one or more convolutional layers. The machine learning model of method 300 may also comprises one or more convolutional blocks, each comprising one or more convolutional layers. A convolutional block is a unit of a CNN, which may comprise one or more convolutional layers. The convolutional blocks may also comprise additional components such as an activation function, normalisation layer, pooling layer, and a dropout layer.

Mathematically, a convolution is an integration function that expresses the amount of overlap of one function g as it is shifted over another function f. Intuitively, a convolution acts as a blender that mixes one function with another to give reduced data space while preserving the information. In terms of neural networks and deep learning, convolutions are filter (matrix/vectors) with learnable parameters that are used to extract low-dimensional features from an input data. They have the property to preserve the spatial or positional relationships between input data points. Convolutional neural networks exploit the spatially local correlation by enforcing a local connectivity pattern between neurons of adjacent layers. In one example, the CNN architecture may comprise an optimal number of convolutional layers, filter size and stride length, for a specific purpose.

Intuitively, a convolution is the step of applying the concept of sliding window (a filter with learnable weights) over the input and producing a weighted sum (of weights and input) as the output. The weighted sum is the feature space which is used as the input for the next layers. More specifically, each convolutional layer comprises a filter, which calculates a weighted sum of pixel values. For example, a 2×2 filter comprises 4 weights, which are the coefficients of the filter. The filter starts at an initial position in the image data structure, multiplies each pixel value in the image data structure with the respective filter coefficient and adds the results. Finally, the filter stores the resulting number in an output pixel. In this sense, the output pixel value of each of the one or more convolutional layers comprises a weighted sum of input pixel values. The weights in the weighted sum correspond to the coefficients of the filter. Then, the filter moves by one pixel along one direction in the data structure and repeats the calculation for the next voxel of the output image. For example, if the stride is 2, the filter will move by two pixels along one direction. That direction may be an x-dimension or a y-dimension.

A single convolutional layer may use multiple filters, where each filter corresponds to a different feature. The corresponding feature of each filter is determined during training of the CNN. More specifically, each filter may contain weights, which are adjusted during a training process through a backpropagation process, for example. The filters are used to quantitatively determine the contribution of a particular feature on the output of the CNN. For a convolutional layer that occurs at the start of a CNN architecture, the filters of this convolutional filter may correspond to simple features. However, convolutional layers that occur later in the CNN architecture may exhibit more complex or abstract features. As an example, the complex or abstract features may be a combination of the simple features from the previous convolutional layer.

In some embodiments, the input image (as well as the training image) is a hyperspectral image (more specifically, a hyperspectral image). A hyperspectral image is a type of digital image that captures a wide spectrum of light beyond what the human eye can see. Unlike traditional images that capture light in just three bands (red, green, and blue), hyperspectral images may capture information across hundreds of contiguous spectral bands. The machine learning models recited in this disclosure may be applied to the whole hyperspectral image (in the case that the machine learning model is a three-dimensional CNN) or may be applied to each spectral band (in the case that the machine learning model is a two-dimensional CNN). The input image (as well as the training image) may also be a multi-spectral image, for example.

In some embodiments, a number of the convolutional blocks of the second machine learning model (i.e., the lightweight model) is less than a number of convolutional blocks of the first trained machine learning model. As such, the model architecture of the second machine learning model is smaller than the first trained machine learning model. For example, the second machine learning model may comprise two convolutional blocks and each of the two convolutional blocks comprises one convolutional layer. It is shown in the experimental results section that this model architecture was used as the lightweight machine learning model. However, it is noted that other lightweight model architectures are possible.

FIG. 4 illustrates a data structure 400 for a hyperspectral image. The data structure 400 comprises layers, one for each wavelength. More specifically, the z direction shown in FIG. 4 represents wavelength. The z dimension may be referred to as the spectral dimension. Each layer represents the radiance values for one wavelength and all pixels and one example pixel 402 is highlighted. The values of pixel 402 for different wavelengths, which is the radiance values from lower layers at the same location as pixel 402, represent a radiance spectrum also referred to as the image spectrum or input spectrum.

In some embodiments of method 200, each of the one or more convolutional layers comprise a number of convolutional kernels, wherein the convolutional kernels of the first trained machine learning model are three-dimensional, and the convolutional kernels of the second machine learning model are two-dimensional. As such, the first machine learning model may have a larger model architecture than the second machine learning model as it comprises three-dimensional convolutional kernels, while the second machine learning model comprises two-dimensional convolutional kernels. In one example, the first and second machine learning model may have the same number of layers (e.g., the same number of convolutional blocks and convolutional layers), but the first machine learning model has a larger architecture as it comprises three-dimensional convolutional kernels.

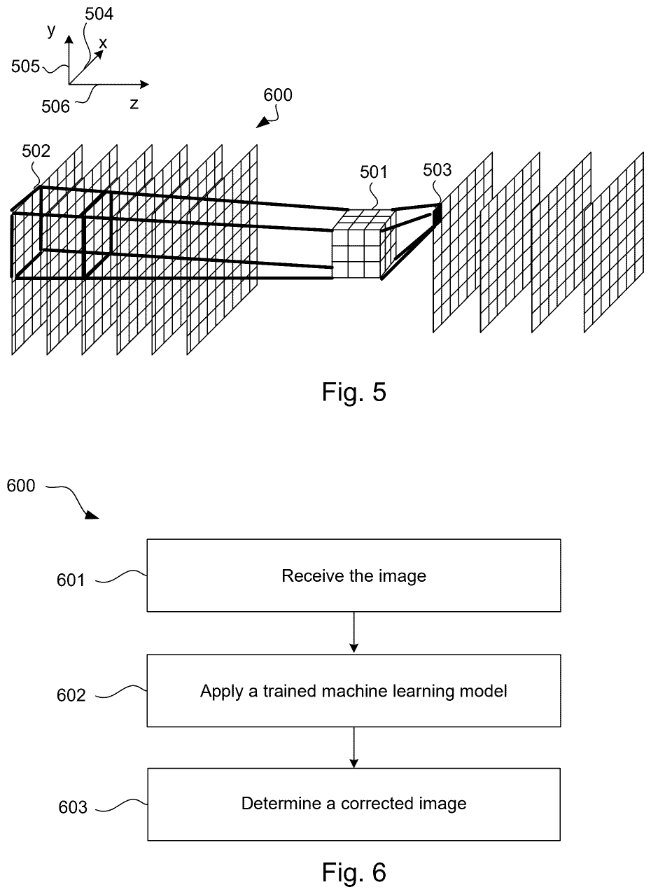

When the first machine learning model comprises three-dimensional convolutional kernels, the convolutions (i.e., the convolutional kernels) are applied in three dimensions. FIG. 5 illustrates a 3D convolution applied to the data structure from FIG. 4. 3D convolutions apply a 3D convolutional filter to the dataset and the filter moves in 3-directions (x, y, z) to calculate the low-level feature representations. Their output shape is a three-dimensional volume space such as cube or cuboid.

In FIG. 5 a filter 501, which is a 3×3×3 filter in this example (but not limited to a 3×3×3 filter), calculates a weighted sum of voxel values. There are 9 weights, which are the coefficients of the filter. So, the filter starts at an initial position 502 in the data structure 400, multiplies each voxel value with the respective filter coefficient and adds the results. Finally, the filter 501 stores the resulting number in an output pixel 503. In this sense, the output voxel values of each of the one or more convolutional layers comprises a weighted sum of input voxel values. The weights in the weighted sum correspond to the coefficients of the filter. Then, the filter moves by one voxel along one direction in the data structure 400 and repeats the calculation for the next voxel of the output image. In the example described above, the filter will move by two voxels along one direction as the stride is 2. That direction may be an x-dimension 504 or a y-dimension 505. Importantly, the filter 501 may also move in space along the spectral dimensions 506 (or wavelength direction). That is, the cubic 3×3×3 filter 501 adds voxel values along the spectral dimension 506 and also moves along the spectral dimension 506. Therefore, this operation is referred to as a convolution along a dimension defined in space along the spatial sequence. It is noted that there are typically more than one filters 501, such as two or more, that create respective 3D output data structures (only one is shown in FIG. 5).

In some embodiments of method 200, 300, the machine learning models are based on a UNet architecture. More specifically, the first trained machine learning model and the second machine learning model of method 200 may be based on a UNet architecture. The machine learning model of method 300 may also be based on a UNet architecture. UNet is a convolutional neural network which are effective for image denoising. The network consists of a contracting path and an expansive path, which gives it the u-shaped architecture. The contracting path is a typical convolutional network that consists of repeated application of convolutions, each followed by a rectified linear unit (ReLU) and a max pooling operation. During the contraction, the spatial information is reduced while feature information is increased. The expansive pathway combines the feature and spatial information through a sequence of up-convolutions and concatenations with high-resolution features from the contracting path.

### Synthetic Dataset

Step 301 of method involves processor 111 partially training a machine learning model using a synthetic dataset comprising synthetic images, wherein the synthetic dataset being generated from surface reflectance images by simulating one or more atmospheric conditions in the surface reflectance images. In some embodiments, the first trained machine learning model of method 200 is trained at least partially on a synthetic dataset comprising synthetic images, wherein the synthetic dataset comprises the training image.

In some embodiments, the synthetic dataset is generated at least partially from top of atmosphere (TOA) images by applying a correction to the TOA images to reduce atmospheric distortion, such as cloud interference. The TOA images may also be referred to as TOA reflectance images. Processor 111 may be configured to generate the synthetic dataset at least partially from the TOA images. TOA images are image captured from the top of Earth's atmosphere, around 100 kilometres above the Earth's surface. The TOA is the place where solar energy (mostly visible light) enters the Earth system and where both reflected light and invisible, thermal radiation from the Sun-warmed Earth exit. TOA images may be raw images captured by an atmospheric satellite. As such, the TOA images may be uncorrected and comprise atmospheric distortion.

Processor 111 may generate the synthetic dataset from TOA images, thereby creating surface reflectance images. Surface reflectance is the reflectance of the surface of the Earth. As clouds and other atmospheric components do not affect surface reflectance spectra, surface reflectance images may not comprise atmospheric distortion. Processor 111 may apply a correction to the TOA images by applying an image processing technique. More specifically, processor 111 may apply an atmospheric correction method to the TOA images to generate the synthetic dataset.

In some embodiments, the synthetic dataset is generated at least partially by simulating one or more atmospheric conditions in the surface reflectance images. For example, processor 111 may simply receive surface reflectance images, without generating these images by applying a correction. Processor 111 may be configured to generate the synthetic dataset at least partially from surface reflectance images. In some examples, processor 111 may simulate one or more atmospheric conditions by adding clouds to the surface reflectance images. In some examples, the synthetic dataset generated for the surface reflectance images may be used as training images, while the corresponding surface reflectance images may be used as ground truth for the training images.

In some embodiments, applying the correction and simulating the one or more atmospheric conditions is based on a physical reflectance model. The physical reflectance model may be indicative of a relationship between TOA reflectance and surface reflectance. The physical reflectance model may be a physics-based model. More specifically, the physical reflectance model may predict the reflectance of light between the sun, the Earth (such as the Earth's surface or the Earth's atmosphere), or a combination thereof. In some examples, processor 111 generates the surface reflectance images from the TOA images using the physical reflectance model. More specifically, processor 111 applies a correction to the TOA images based on the physical reflectance model.

In some embodiments, the physical reflectance model is configured using one or more atmospheric parameters, the one or more atmospheric parameters being one or more of: aerosol type; optical depth; water vapor; surface elevation; view zenith; azimuth angle; and solar zenith angle.

In some embodiments, the physical reflectance model is based on Equation 1. For accuracy, the Earth's surface may be approximated as a Lambertian surface (light falling on it is scattered such that the apparent brightness of the surface to an observer is the same regardless of the observer's angle of view). For a Lambertian surface, the TOA reflectance is expressed as:

$${R}_{TOA} ( {P}_{a} ; {θ}_{s} , {θ}_{v} , ϕ ) = {R}_{atm} ( {P}_{a} ; {θ}_{s} , {θ}_{v} , ϕ ) + \frac{{T}_{a} ( {P}_{a} , {θ}_{s} ) {T}_{s} ( {P}_{a} , {θ}_{v} ) A}{1 - \overline{r} ( {P}_{a} ) A} \qquad ( 1 )$$

where R_{TOA} is TOA reflectance, A is surface reflectance (or albedo when the surface is assumed to be Lambertian), Rₐₜₘ is the reflectance due to atmosphere only with the surface absent (zero reflectance), Tₐ, Tₛ, and r̅ are functions depending on atmosphere parameters. Tₐ is the diffuse transmittance function from the sun to the surface, Tₛ is the diffuse transmittance function from surface to the sun, and r̅ is the atmosphere global reflectance function at bottom of the atmosphere. Pₐ represents the full set of atmosphere parameters, θₛ is the solar zenith angle, θᵥ is the view zenith angle, ϕ is the relative azimuth angle between the sun and the satellite. All the variables in the equation may depend on wavelength. Rₐₜₘ, Tₐ, Tₛ, and r̅ may be pre-calculated and saved in look-up tables, as will be discussed later in this disclosure. From R_{TOA}, the surface reflectance can be calculated as:

$$A = \frac{Δ R}{Δ R \overline{r} + {T}_{a} {T}_{s}} \qquad ( 2 )$$

where ΔR=R_{TOA}−Rₐₜₘ and A is the surface reflectance.

### Method for Atmospheric Correction

FIG. 6 illustrates method 600 for atmospheric correction of an image comprising atmospheric distortion. Similar to FIGS. 2 and 3, FIG. 6 is to be understood as a blueprint for a software program.

Processor 111 receives 601 the image. Processor 111 may receive 601 the image by retrieving the image stored on memory 112. Device 110 may also be in communication with an external server and may retrieve the image stored on the external server. In some examples, processor 111 may be in communication with an image sensor (i.e., a camera) configured to capture the image. The image sensor may then communicate the image to the processor 111 after capturing the image.

Processor 111 then applies 602 a trained machine learning model to the image. The trained machine learning model is trained using the method 200, 300. For example, the trained machine learning model described in method 600 may be the second trained machine learning model of method 200, trained using knowledge distillation. In another example, the trained machine learning model described in method 600 may be the trained machine learning model of method 300, trained using layer freezing. The trained machine learning model may also be a compressed machine learning model. The trained machine learning model of method 600 may also be the first trained machine learning model of method 200. However, preferably, the trained machine learning model of method 600 is of a smaller architecture for computational efficiency and to reduce memory storage requirements.

Finally, processor 111 determines 603 a corrected image based on an output of the trained machine learning model. For example, the corrected image may simply be the output of the trained machine learning model. In other examples, processor 111 may apply further image processing to the output of the trained machine learning model to determine the corrected image.

### Experiments

Experiments to test the performance of the disclosed methods will now be discussed. In particular, the performance of the machine learning models described herein (e.g., the machine learning models trained using the method 200) are evaluated using the following experiments. In the experiments described herein, a dataset of satellite images was used to demonstrate the performance of the machine learning models described herein. However, as noted before, the methods and systems described herein are applicable for other airborne and space-borne systems.

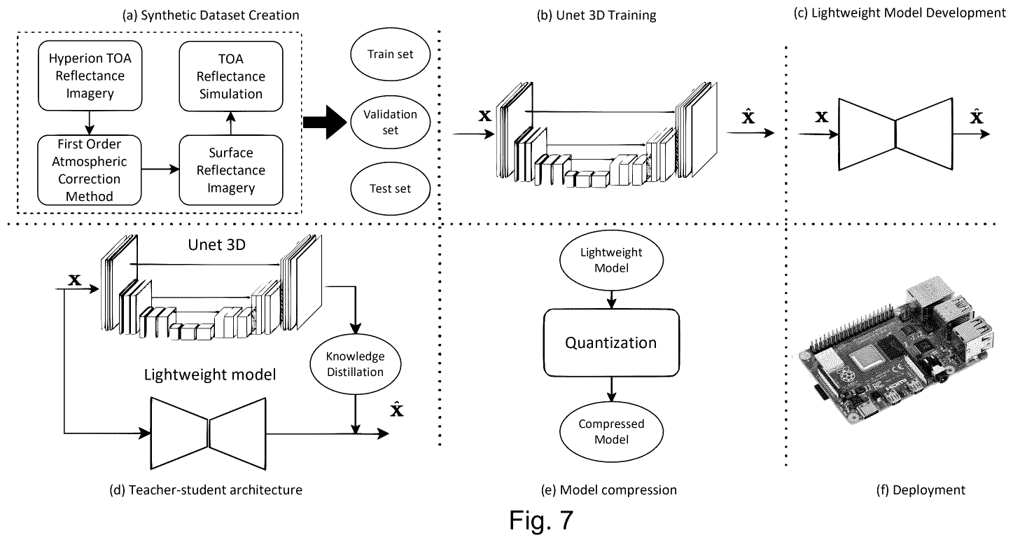

FIG. 7 illustrates the atmospheric correction workflow used to obtain the experimental results described herein. The workflow comprises six main steps: (a) The generation of synthetic hyperspectral images for training a machine learning model; (b) The training of a machine learning model with 3D convolutional kernels and based on a UNet architecture for the atmospheric correction task; (c) The development of lightweight machine learning model comprising 2D convolutional kernels and based on the UNet architecture; (d) The use of the student-teacher framework to train the lightweight model (i.e., method 200); (e) Compression of the model by way of static quantisation for deployment on resource-constrained edge devices; and (f) Deploy the compressed machine learning model onto a Raspberry Pi 4 device.

### Data Simulation

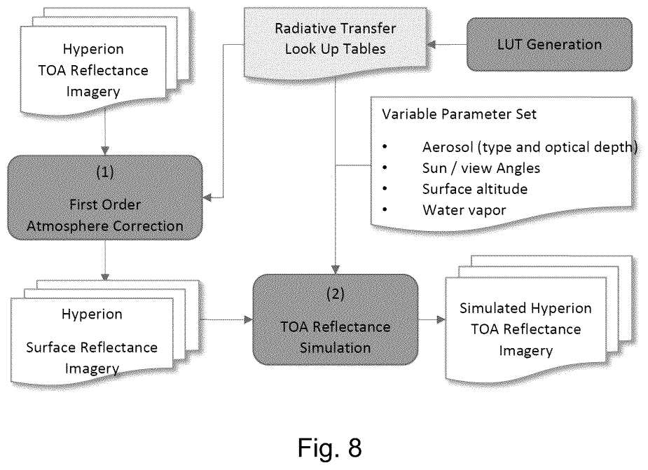

This section discusses the generation of the synthetic dataset used to train the machine learning models. More specifically, this section discusses the simulation of Hyperion hyperspectral Top of the Atmosphere (TOA) reflectance data for the development of the AI-based atmospheric correction model (i.e., the lightweight machine learning model) over land. FIG. 8 shows the steps of the simulation which will be discussed in detail in the following sections. More specifically, FIG. 8 shows a flow chart for the generation of simulated Hyperion imagery. Although, the synthetic dataset was generated using the Hyperion dataset in the experiments described herein, the techniques for synthetic dataset generation can be employed for other remote sensing multispectral and hyperspectral datasets.

Surface reflectance by first order atmospheric correction

Having a representative dataset comprising devise training data enables the machine learning model trained with the dataset to be robust and accurate. In the application of atmospheric correction, it is preferable to have a dataset that encompasses TOA reflectance, surface reflectance, and atmospheric and geometric conditions that establish the connection between surface and TOA reflectance. Preferably, the dataset meets two criteria: 1) encompassing expected surface types, and 2) providing a realistic approximation of actual reflectance spectra. Realism is preferable, however accuracy in surface/TOA reflectance is not an obligatory prerequisite for the dataset.

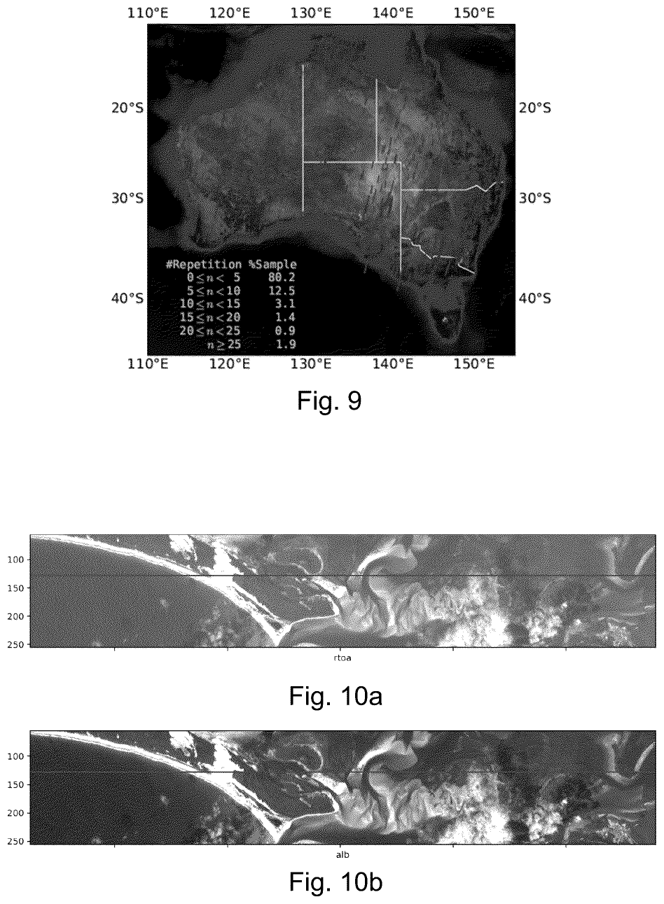

The experiments described herein utilised a dataset consisting of 1270 Hyperion images that span the Australian continent. Compiled over a decade from 2000 to 2010, these images include 256 bands within the visible to near-infrared spectral range. FIG. 9 illustrates the dataset's almost uniform coverage across the entire continent, offering a representation of diverse surface types. More specifically, FIG. 9 shows the spatial distribution of the Hyperion images used to provide input surface reflectance to the simulation of TOA reflectance, showing wide spatial coverage.

The TOA satellite image set from the Hyperion image set primarily comprises satellite images with cloud-free conditions, although some cloud presence is observed. To address this, an automated algorithm was initially employed to mask cloudy and shadowed areas. The algorithm effectively handled cumulus clouds, characterized by isolation and distinct boundaries. However, it exhibited significant limitations with more uniform stratus clouds and overly masked cloud shadows. Consequently, cloud masking was refined through visual inspection of all 1270 RGB composite images. Following this process, 630 sections of cloud-free images were retained for this study.

The next phase involves the conversion of TOA reflectance to surface reflectance. In machine learning and for the purposes of this project, precision in surface reflectance is not crucial; instead, a realistic approximation to the true surface is sought. To achieve this, a first-order correction was applied to derive the TOA reflectance images, based on Equation 1 using the atmospheric and geometric parameters as shown in Table 1.

TABLE 1
Parameters used in the first order correction.

| Parameter | Value |
|---|---|
| Atmosphere model | US62 standard |
| Aerosol type and optical depth | Aged smoke, 0.025 |
| Water vapor | 1.5 cm-atm |
| Surface elevation | 0.0 km |
| View zenith and azimuth angle | 0°, 0° |
| Solar zenith angle | Calculated from latitude, longitude, |
| | and time |

The US62 standard atmosphere model was selected to characterize the overall atmospheric conditions. Aged smoke aerosol was chosen due to its prevalence as the predominant aerosol type in the Australian continent. The aerosol optical depth (AOD) was established at 0.025, representing the baseline level of aerosol loading. Additionally, a water vapor value of 1.5 cm-atm was employed, approximating the average for the Australian continent. It is noted that a consistent surface elevation of 0 km above sea level was employed in the experiments described herein, potentially necessitating adjustments, particularly in regions of higher altitude. As Hyperion conducted scans along the track in the near nadir range, covering a narrow swath of 7.5 km from a satellite positioned 820 km above the surface, the view zenith angle and relative azimuth angle were both set at 0°. The sun zenith angle was determined using the actual (albeit approximate) location and time of each image.

In conducting the necessary radiative transfer calculation to derive surface reflectance from TOA reflectance, it was assumed that the surface (i.e., the Earth's surface) is Lambertian. This means that the surface reflects light uniformly in all directions. This choice was motivated by the unavailability of high-resolution Bidirectional Reflectance Distribution Function (BRDF) data, which describes the angular pattern of the surface's reflection. Furthermore, the accurate “true” surface reflectance was not deemed necessary.

Look up tables were generated to include a diverse set of atmospheric and geometrical parameters associated with the Hyperion bands. This process utilised the Vector Green's function and Discrete Ordinate Method (VGDOM) radiative transfer code. VGDOM is based on the Discrete Ordinate Method (DOM), which is one way to approximately solve the radiative transfer equation by discretising both the xyz-domain and the angular variables that specify the direction of radiation. VGDOM is an accurate numerical solver for the radiative transfer equation, in contrast to the approximate analytical solutions. The VGDOM code can be further extended to solve the radiative transfer equations for a wider range of light sources, to consider full polarization and general BRDF surface, and to compute the Green's function. The VGDOM code has been applied in various practical scenarios, with a specific focus on its role in retrieving aerosol and BRDF data.

However, other look up tables of atmospheric parameters may be used in other examples. Other solvers or models may also be used.

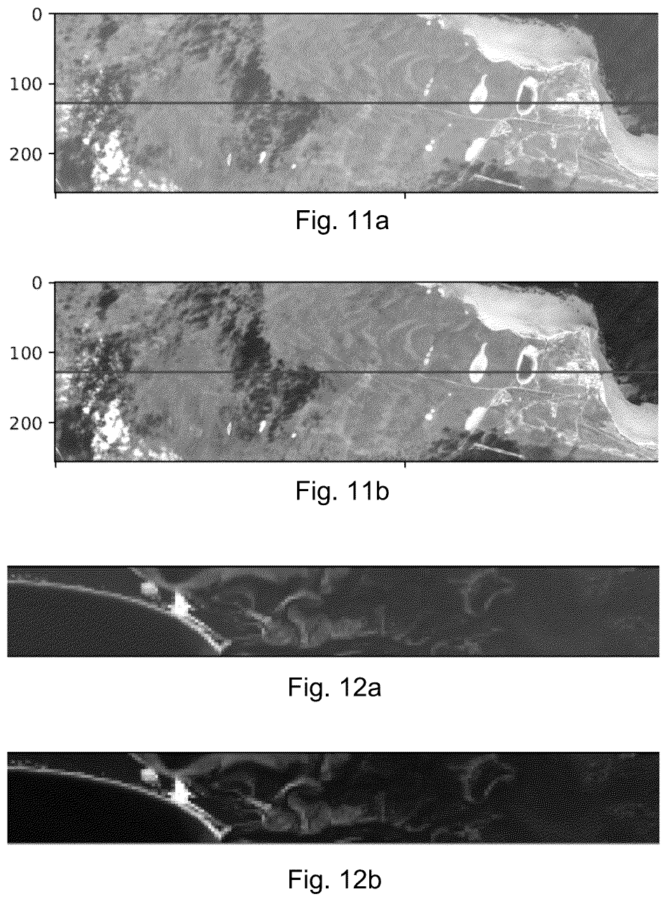

Examples of the first order correction results are shown below, where the top panels show the TOA reflectance and the bottom panels show the surface reflectance. FIG. 10 shows example satellite images in the first order correction process. FIG. 10a shows the TOA reflectance image used as input and FIG. 10b shows the resulting surface reflectance image after the first order correction. FIG. 11 shows a further example of satellite images in the first order correction process. Expected visual effects may be due to the atmosphere correction include removal of bluish mist in the TOA image and sharper contrast in the surface image.

An analysis of the first-order corrected surface reflectance shows that a minor subset of images exhibited negative reflectance in certain pixels, particularly in water pixels and the blue spectral region, which is physically implausible. To address this issue, a corrective measure was applied by setting the reflectance to zero for these specific pixels and bands. Although these pixels and bands are not inherently black, this adjustment does not impact the development of the machine learning model.

### Simulation of TOA Reflectance

From the surface reflectance satellite images, generated using the first order correction method described above, the synthetic dataset is then generated from the surface satellite images by modelling or simulating various atmospheric conditions, such as cloud interference and the like. In particular, new TOA satellites images were generated from the surface reflectance satellite images. In essence, an unlimited number of training images can be generated from the corrected surface reflectance satellite images.

Utilizing the surface reflectance data cleared of cloud interference, TOA reflectance images were calculated for an extensive array of atmospheric and geometrical parameters outlined in Table 2, where AOT is the Aerosol Optical Thickness. The calculations were performed using Equation 1 and the lookup tables generated by VGDOM. Initially, a foundational parameter set was established to represent common conditions in the Australian continent. However, other parameters can be used to represent other continents. The data volume was also managed to maintain a relatively small parameter database.

TABLE 2
Atmospheric and geometrical parameters
for TOA reflectance simulation

| Parameter | |
|---|---|
| Name | Parameter Value |
| Aerosol | Type = Smoke, AOT = 0.0 |
| | Type = Smoke, AOT = 0.05 |
| | Type = Dust, AOT = 0.05 |
| Elevation | 250 meters |
| | 0, 500 meters |
| Water Vapor | 1.5 cm-atm |
| | 2.5 cm-atm |
| Zenith Angle | 0°, 20°, 35°, 50° 30°, |
| | 60° |
| Azimuth Angle | 0°, 45°, 90°, 135°, 180° |

Five batches of simulations have been generated as shown in Table 3. In total, 845 simulated TOA reflectance images were generated for each of the 630 surface reflectance images. In these experiments, only the base set was employed. The resolution was reduced from the original 30 meters to 240 meters, by averaging each 8×8 block of pixels, to speed up the training process. An example of the simulated TOA reflectance image, together with the surface reflectance image, is shown in FIG. 12. FIG. 12a shows an example simulated TOA reflectance image and FIG. 12b shows the input surface reflectance image used to generate the example simulated TOA reflectance image of FIG. 12a.

TABLE 3
Simulation batches

| Batch | Parameters | No. Simulations |
|---|---|---|
| 1 | Base set | 150 |
| 2 | Base set replacing aerosol by extension | 200 |
| | values | |
| 3 | Base set replacing elevation by extension | 300 |
| | values | |
| 4 | Base set replacing water vapor by extension | 150 |
| | values | |
| 5 | Base set replacing zenith angle by extension | 45 |
| | value | |
| Total | | 845 |

### Machine Learning Models

The machine learning models employed for atmospheric correction in these experiments are now discussed. Formally, given a hyperspectral image, captured by an airborne or space platform (such as a satellite), denoted as I∈␣^{m×n×k}, where m and n represent the spatial dimensions, and k is the number of spectral bands, the observed data is inherently affected by atmospheric conditions (i.e., atmospheric distortion), leading to distortion and inaccuracies. The primary objectives of the experiments described herein include:
1. To create a workflow using CNN learning techniques for learning the TOA reflectance to surface reflectance transformation for hyperspectral images;
2. To train various versions of UNet, such as the traditional 2D kernel model (M_{2D}), a 3D kernel model (M_{3D}), and a lightweight 2D kernel model (M_{LW}), and then compare their performance;
3. To utilize knowledge transfer or the student-teacher model to train a lightweight version of UNet (i.e., method 200); and
4. To integrate a quantisation approach to enhance model optimization, ensuring compatibility with RPi4 without compromising the accuracy of atmospheric correction.

### UNet 2D Model

The UNet model is a CNN architecture originally designed for semantic segmentation tasks in image processing and computer vision. The UNet architecture is characterized by a U-shaped structure, with a contracting path followed by an expansive path. The contracting path consists of convolutional and pooling layers that capture hierarchical features, while the expansive path uses transposed convolutions to achieve precise localization. The model's skip connections between corresponding layers in the contracting and expansive paths help preserve fine-grained details.

### UNet 3D Model

Employing 3D kernels within the UNet framework accounts for both spatial and spectral contexts in 3D input data, such as hyperspectral data. This approach enhances the precision of the predicted surface reflectance. However, integrating 3D kernels significantly prolongs both training and inference times. Therefore, knowledge distillation is used to transfer the knowledge of the more accurate model, in this case the UNet with 3D kernels, to a lightweight model.

### Motivation for Using a Lightweight Model

The 2D UNet and 3D UNet models come with a couple of disadvantages, particularly when considering deployment on resource-constrained edge devices. Firstly, both 2D and 3D UNet models can be computationally intensive and memory-demanding, especially when dealing with high-resolution images or large-scale datasets. The complex network structures and large number of parameters often require substantial computational resources, making them unsuitable for deployment on resource-constrained edge devices with limited processing power and memory capacity. Secondly, the large model size of traditional UNet architectures can lead to longer inference times, which may not be desirable in real-time applications where rapid processing and response are crucial. These issues are not limited to UNet models, rather similar issues are present for other model architectures.

These limitations highlight the need for developing lightweight models tailored for edge computing environments. The motivation behind developing lightweight models, such as lightweight UNet, lies in addressing these challenges by designing compact architectures that offer efficient inference while maintaining satisfactory performance. By reducing model complexity, parameter count, and computational overhead, lightweight models enable seamless deployment on edge devices without compromising accuracy or functionality.

For instance, for atmosphere correction, deploying a lightweight UNet model on edge devices allows for on-device processing of satellite imagery to perform fast correction of atmospheric effects. This capability can enable applications such as environmental monitoring, precision agriculture, and disaster response to benefit from timely and accurate image processing directly on the edge, without the need for constant connectivity or reliance on cloud-based processing.

### Proposed Lightweight UNet Model

The UNet architecture is inherently complex and challenging to use on edge devices with limited memory and processing power. To simplify the UNet structure, the number of convolutional blocks were reduced from four to two, each containing only one convolutional layer. This modification maintains the ability of the model to learn the TOA reflectance to surface reflectance transformation while enhancing the model's efficiency. As a result, the model reduces computational expenses, leading to faster training and inference times, making it ideal for deployment in resource-constrained environments.

### Loss Function

Training a deep learning model involves supplying annotated training data, defining a loss function, and optimizing the model parameters using algorithms like stochastic gradient descent. In the experiments described herein, the Mean Squared Error (MSE) loss function was used. The MSE loss is expressed as:

$$MSE \frac{1}{N} {\sum }_{i = 1}^{N} {\sum }_{j = 1}^{N} {( {X}_{ij} - {\hat{X}}_{ij} )}^{2}$$

Here, N represents the number of pixels in each image, M is the total number of images in the dataset, Xᵢⱼ denotes the pixel intensity of the corrected image (i.e., the surface reflectance satellite image) at position (i, j), and Xᵢⱼ represents the corresponding pixel intensity of the reconstructed image. Here, the corrected image (i.e., the surface reflectance satellite image) correspond to the ground truth (GT) image. The MSE loss computes the mean squared difference between the ground truth and reconstructed pixel intensities, providing a measure of the overall reconstruction error. Minimizing this loss during training helps the UNet model learn to reconstruct corrected images.

### Student-Teacher Training

The student-teacher model, employing the UNet architecture and incorporating knowledge distillation, is a technique designed to transfer the knowledge of a complex and accurate “teacher” model to a more lightweight “student” model. In other words, this involves distilling the knowledge of M_{3D} into M_{LW}. The teacher model serves as a guide, providing the student with valuable insights during training. The distillation process typically involves minimizing a combined loss function that includes both the conventional MSE loss between the student's predictions and ground truth MSE_{s,gt} and an additional knowledge distillation loss, which in this case is also the MSE_{s,t}. The knowledge distillation loss encourages the student to mimic the soft probabilities produced by the teacher, allowing it to benefit from the rich information encoded in the teacher's predictions. The combined loss function is expressed as:

$$Total Loss = λ \cdot {MSE}_{s . t} + ( 1 - λ ) \cdot {MSE}_{s . gt}$$

Here, λ is a hyperparameter that controls the trade-off between the two components of the loss.

### Onboarding Processing

As mentioned previously, the aim of the experiments described herein is to formulate an AI-driven (i.e., a machine learning) atmospheric correction solution suitable for deployment on satellite hardware, with a specific emphasis on onboard processing. The trained lightweight model, after knowledge distillation, can now be deployed on the RPi4 device. However, to further reduce the size of the model and make it even more computationally efficient, static quantisation is employed. This technique involves quantizing the weights and activations of M_{LW} to a lower bit precision (from 32-bit floating-point to 8-bit integers) while keeping the structure of the network fixed. Layer fusion, an optimization technique that combines multiple operations into a single operation, was also employed to improve computational efficiency.

In the second phase of the onboard processing method, post quantisation, the quantized model is deployed onto RPi4. This step involves running the quantized model on the Raspberry Pi's CPU, and comparing the results, including inference times, with a non-quantized version of the model. By validating the proposed solution on RPi4, it was aimed to establish its practicality for real-world applications for atmospheric correction, where efficient onboard processing is preferably for timely and accurate data analysis.

### Experimental Results

This section describes details pertaining to the training process, the evaluation metrics and provides both numerical and visual results.

### Training Details

As mentioned previously, a UNet deep learning network with 3D kernels was used as the main model for the atmospheric correction task using the Pytorch framework. For all experiments, the batch size was empirically set to 4, the number of epochs to 100, and the learning rate to 0.001. For the student-teacher model, hyperparameter λ was set to 0.7 in all experiments. Stochastic Gradient Descent (SGD) with momentum 0.9 was employed.

### Evaluation Metrics

In the experiments described herein, the performance of the machine learning model trained using the embodiments of method 200 (i.e., the lightweight model and compressed model) are compared to traditionally trained machine learning models (i.e., the 3D UNet and 2D UNet). More specifically, the following machine learning models were compared: a 2D kernel model (M_{2D}), a 3D kernel model (M_{3D}), a lightweight 2D kernel model (M_{LW}), a lightweight 2D kernel model trained using student-teacher learning (M_{ST}), and a compressed version of M_{LW} compressed using quantisation (M_{Q}).

The task of atmospheric correction is to retrieve surface reflectance values (denoted as Â) from observed TOA reflectance data, accounting for the interference caused by atmospheric scattering and absorption. This process is mathematically represented as:

$$\hat{A} = f ( TOA ) \qquad ( 3 )$$

where f is the atmospheric correction function (which may be one of the machine learning models described herein). To evaluate the performance of atmospheric correction methods, two metrics employed are the Mean Absolute Error (MAE) and the MSE. The MAE and MSE quantify the dissimilarity between the estimated surface reflectance values Â and the true ground truth surface reflectance values (denoted as Aground truth). The MAE and MSE are defined as:

$$MAE = \frac{1}{N} {\sum }_{i = 1}^{N} \vert {\hat{A}}_{i} - {A}_{ground truth , i} \vert \qquad ( 4 )$$

$$MAE = \frac{1}{N} {\sum }_{i = 1}^{N} {( {\hat{A}}_{i} - {A}_{ground truth , i} )}^{2} \qquad ( 5 )$$

Here, N represents the total number of pixels in the dataset. Both MAE and MSE serve as quantitative measures that assess the extent to which the correction process aligns the predicted surface reflectance with the actual surface reflectance. Lower MAE and MSE values indicate a closer match between the predicted surface reflectance (Â) and the actual surface reflectance (A_{ground truth}).

The choice between MAE and MSE depends on specific goals and how errors in the atmospheric correction process are to be measured and emphasised. In the training processing, if the magnitude of the error is large, avoiding heavy penalties for outliers is desired, then MAE may be a suitable choice. However, in the experiments described herein, there are large number of noise pixels in training data, and it is desirable to give more weights to larger errors and emphasize the importance of minimizing them, therefore, MSE is more appropriate. As such MSE is used to calculate the loss in the experiments described herein.

### Training Convergence Curves

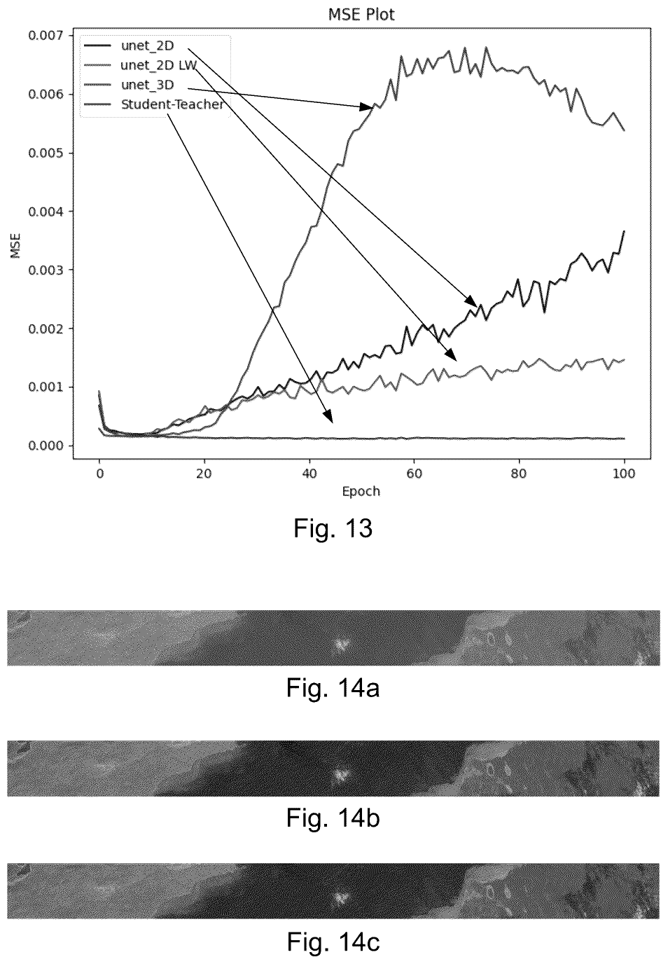

The model was trained using the synthetic dataset as previously described, and its validation and testing were performed on Hyperion TOA reflectance images. The Hyperion images used for creating the synthetic dataset, and the validation and testing sets were all separated geographically across the Australian landmass. The convergence curves using different methods on the validation dataset are shown in FIG. 13. From FIG. 13, it can be seen that all the methods converge within the first 10 epochs. Notably, M_{3D} performs the best, which converges within 2 epochs, and then maintains stability until the 20th epoch. However, after the 20th epoch, its MSE increases dramatically, and that is because M3D has more parameters and thus a larger capacity to learn patterns from the data, making it more susceptible of overfitting. Since the model is trained on the synthetic data while validating and testing it on real images, a large distribution shift or domain gap is present. Thus, as the training progresses, the overfitting issue becomes more profound, leading to an increase in MSE.

The MSE curves of the M_{2D} and M_{LW} models show a similar pattern; initially decreasing and then rising with substantial fluctuations. However, their MSEs remain lower than that of M_{3D} due to their fewer parameters, resulting in reduced overfitting.

Regarding the student-teacher model, the student model aims to mimic the teacher's behaviour and minimize the feature representation gap between them. Therefore, the MSE between the teacher and student model should be small and approach zero. In essence, both the M_{2D} and M_{LW} suffer from underfitting due to their limited number of parameters, whereas the M_{3D} model faces overfitting because of its abundance of trainable parameters. However, the proposed student-teacher structure effectively addresses both the underfitting and overfitting concerns.

### Numerical Experimental Results

Table 4 shows the sizes of models, inference times, as well as MAE and MSE values for the non-synthetic test dataset, comparing surface reflectance to TOA reflectance across different models. Notably, M_{LW} and M_{ST} exhibit identical model sizes and inference times per patch, both significantly lower than M_{2D} and M_{3D}. Interestingly, in terms of MAE and MSE, M_{ST} demonstrates better performance compared to M_{3D}, indicating that incorporating learning from M_{3D} and the dataset results in improved outcomes.

TABLE 4
Experimental results using different methods on the GPU.

| | | | Inference time | Metrics | |
|---|---|---|---|---|---|
| Methods | Model Size | | per patch (ms) | MAE | MSE |
| GT/RTOA | — | | — | 2.85 × 10⁻² | 1.80 × 10⁻³ |
| M_{2D} | 238 | MB | 3.3 | 1.11 × 10⁻² | 2.31 × 10⁻⁴ |
| M_{LW} | 1.7 | MB | 1.0 | 1.12 × 10⁻² | 2.41 × 10⁻⁴ |
| M_{3D} | 1.6 | GB | 3.4 | 8.75 × 10⁻³ | 2.0 × 10⁻⁴ |
| M_{ST} | 1.7 | MB | 1.0 | 7.90 × 10⁻³ | 1.30 × 10⁻⁴ |

### Visualizations

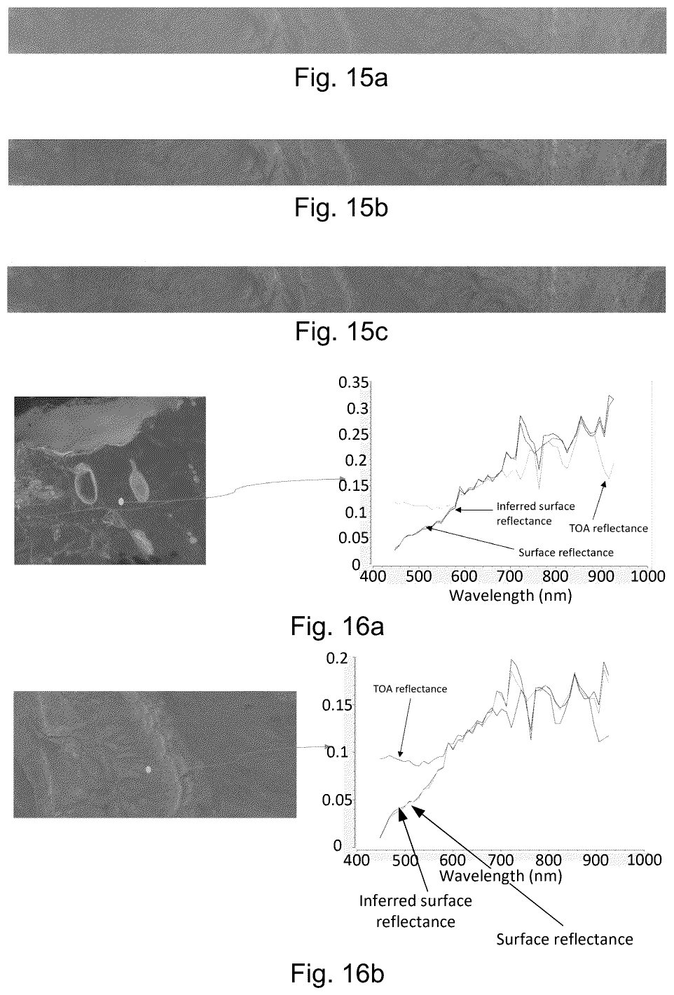

In this section, visual comparisons of the TOA reflectance, ground truth surface reflectance, and inferred surface reflectance of the proposed model from the test set are shown. FIGS. 14 and 15 demonstrate that the surface reflectance derived from the physics-based model and the inferred surface reflectance match closely, which concurs with the quantitative results. The depicted results encompass images featuring both land and water surfaces, as well as images featuring just land.

FIG. 14a and FIG. 15a shows a visualization of TOA reflectance for land and water surfaces. FIG. 14b and FIG. 15b shows a visualization of surface reflectance for land and water surfaces. FIG. 14c and FIG. 15c shows a visualization of inferred surface reflectance for land and water surfaces.

FIG. 16a shows the TOA reflectance, inferred surface reflectance and the surface reflectance (from the physics-based model) for a pixel for the images in FIG. 14a-c as spectral plots. FIG. 16b shows the TOA reflectance, inferred surface reflectance and the surface reflectance (from the physics-based model) for a pixel for the images in FIG. 15a-c. FIG. 16 clearly illustrates a very strong alignment between the spectrum inferred by MST and the spectrum obtained from the physics-based model.

### Results for Onboard Processing

In this section, the results obtained with the RPi4 are presented as a way to comparatively assess quantized versus non-quantized models. Both M_{LW} and its quantized counterpart, M_{Q}, were executed on a subset of the validation dataset due to disk space constraints. Table 5 demonstrates that the quantized model has significantly reduced size and inference time when compared to the M_{LW} model. Meanwhile, there has been a slight increase in error, which suggests promising potential for implementing model quantisation for on-board processing.

TABLE 5
Experimental results of different methods on the RPi4.

| | | | Inference time | Metrics | |
|---|---|---|---|---|---|
| Methods | Model Size | | per batch (ms) | MSE | MAE |
| M_{LW} | 1.7 | MB | 60 | 1.13 × 10⁻² | 2.41 × 10⁻⁴ |
| M_{Q} | 233 | KB | 10 | 1.25 × 10⁻² | 2.71 × 10⁻⁴ |

### Conclusion

This disclosure presents an AI-based solution for atmospheric correction in remote sensing for resource-constrained spaceborne systems. The major contributions of this work are:
1. Utilizing available remote sensing data and applying a physics-based method for atmospheric correction to produce an extensive synthetic dataset resembling typical atmospheric conditions and geographic terrains; and
2. An AI processing workflow encompassing the generation of synthetic datasets, optimal model training, integration of knowledge distillation to train a lightweight model, and subsequent model compression through static quantisation for spaceborne applications.

The successful deployment on the Raspberry Pi4 platform demonstrates the practicality and feasibility of the proposed solution for autonomous, onboard processing in resource-constrained environments.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for training a machine learning model to perform atmospheric correction on an input image comprising atmospheric distortion, the method comprising:
applying a first trained machine learning model to a training image to determine a first output image, the first trained machine learning model being configured to perform atmospheric correction on an input image comprising atmospheric distortion;
applying a second machine learning model to the training image to determine a second output image, wherein the second machine learning model has a smaller model architecture than the first trained machine learning model; and
training the second machine learning model by minimising a loss based on the first output image and the second output image to determine a second trained machine learning model.

2. The method of claim 1, wherein the first trained machine learning model is trained at least partially on a synthetic dataset comprising synthetic images, wherein the synthetic dataset comprises the training image.

3. The method of claim 2, wherein the synthetic dataset is generated at least partially from top of atmosphere (TOA) images by applying a correction to the TOA images to reduce the atmospheric distortion.

4. The method of claim 2, wherein the synthetic dataset is generated at least partially from surface reflectance images by simulating one or more atmospheric conditions in the surface reflectance images.

5. The method of claim 4, wherein applying the correction and simulating the one or more atmospheric conditions is based on a physical reflectance model, the physical reflectance model being indicative of a relationship between TOA reflectance and surface reflectance.

6. The method of claim 5, wherein the surface reflectance images are generated from the TOA images using the physical reflectance model.

7. The method of claim 5, wherein the physical reflectance model is configured using one or more atmospheric parameters, the one or more atmospheric parameters being one or more of:
aerosol type;
optical depth;
water vapor;
surface elevation;
view zenith;
azimuth angle; and
solar zenith angle.

8. The method of claim 1, wherein the method further comprises determining a compressed machine learning model by applying a quantisation algorithm or layer fusion algorithm to the second trained machine learning model, the compressed machine learning model having a smaller model architecture than the second trained machine learning model.

9. The method of claim 1, wherein the first trained machine learning model and the second machine learning model are a neural network comprising one or more convolutional blocks, each of the one or more convolutional blocks comprising one or more convolutional layers.

10. The method of claim 9, wherein each of the one or more convolutional layers comprise a number of convolutional kernels, wherein the convolutional kernels of the first trained machine learning model are three-dimensional, and the convolutional kernels of the second machine learning model are two-dimensional.

11. The method of claim 9, wherein a number of the convolutional blocks of the second machine learning model is less than a number of convolutional blocks of the first trained machine learning model.

12. The method of claim 9, wherein the second machine learning model comprises two convolutional blocks and each of the two convolutional blocks comprises one convolutional layer.

13. The method of claim 1, wherein the first trained machine learning model and the second machine learning model are based on a UNet architecture.

14. The method of claim 1, wherein the images are hyperspectral images.

15. The method of claim 2, wherein
the first trained machine learning model is partially trained using the synthetic dataset; and
the first trained machine learning model is further trained using surface reflectance images to finely tune the first partially trained first machine learning model.

16. The method of claim 15, wherein the first trained machine learning model is further trained using layer freezing with one or more frozen layers, the one or more frozen layers corresponding to layers with fixed weights during the further training.

17. The method of claim 1, wherein the method further comprises performing atmospheric correction of an image comprising atmospheric distortion by:
receiving the image;
applying the second trained machine learning model; and
determining a corrected image based on an output of the trained machine learning model.

18. A non-transitory computer readable medium with program code stored thereon that, when executed by a computer, causes the computer to perform the method of claim 1.

19. A system for training a machine learning model to perform atmospheric correction on an input image comprises atmospheric distortion, the system comprising a processor configured to perform the method of claim 1.
